(19) United States
(12) Patent Application Publication
(10) Pub. No.: US 2026/0008295 A1
(43) Pub. Date: Jan. 8, 2026

(54) MINTING METHOD FOR PRODUCING A COIN

(71) Applicant: B.H. Mayer’s Kunstprägeanstalt GmbH, Karlsfeld (DE)

(72) Inventor: Christian STEPHAN, Unterschleißheim (DE)

(21) Appl. No.: 19/256,751

(22) Filed: Jul. 1, 2025

(30) Foreign Application Priority Data
Jul. 2, 2024 (DE) 10 2024 118 690.9

(51) Int. Cl. B44B 5/00; B44B 5/02

(52) U.S. Cl. CPC B44B 5/009; B44B 5/0052; B44B 5/026

(57) ABSTRACT

The present invention relates to a minting method for producing a coin (100), comprising the steps of preforming a relief (105-1, 105-2) for the coin (100); and subsequently minting the relief (105-1, 105-2) with a coin die (107-1, 107-2).

The present invention relates to a minting method for producing a coin.

It is the technical task of the present invention to produce a coin with a particularly high relief and good quality.

This technical task is solved by subject matter according to the independent claims. Technically advantageous embodiments are the subject matter of the dependent claims, the description and the drawings.

According to a first aspect, the technical task is solved by a minting method for producing a coin, comprising the steps of preforming a relief for the coin; and subsequently minting the relief with a coin die. The method achieves the technical advantage that a coin with a high relief can be produced in a particularly good quality. As the motif of the relief is already present in the coin blank, there is no major material transport during the subsequent minting process.

In a technically advantageous embodiment of the minting method, the relief is preformed by means of a milling process. This achieves the technical advantage, for example, that the relief can be preformed particularly efficiently.

In a further technically advantageous embodiment of the minting method, a first relief is preformed on one side and a second relief is preformed on an opposite side. This achieves the technical advantage, for example, that a coin with a particularly high relief on both sides can be produced.

In a further technically advantageous embodiment of the minting method, a first relief is subsequently minted on one side by a first coin die and/or a second relief is subsequently minted on an opposite side by a second coin die. This also achieves the technical advantage, for example, that a coin with a particularly high relief on both sides can be produced efficiently.

In a further technically advantageous embodiment of the minting method, the relief has a height of at least 100% of the thickness of the coin blank, preferably a height of at least 150% or 200% of the thickness of the coin blank. This achieves the technical advantage, for example, that a particularly forgery-proof coin is produced.

In a further technically advantageous embodiment of the minting method, the relief is preformed in a plate. The plate can be of such a size that it can be used to preform several reliefs arranged next to each other, each for one coin. This achieves the technical advantage, for example, that the production of the relief is simplified and several coin blanks can be produced quickly and easily with one clamping operation of the plate.

In a further technically advantageous embodiment of the minting method, the first side and/or the second side of the plate is face-milled. This achieves the technical advantage, for example, that unevenness or deviations of the plate can be compensated for and the quality of the minting is improved.

In a further technically advantageous embodiment of the minting method, a coin blank is cut out of the plate. This achieves the technical advantage, for example, of simplifying the production of the coin blank.

In a further technically advantageous embodiment of the minting method, the preformed relief is heated before the subsequent minting. Heating the blank increases the malleability of the coin blank. This achieves the technical advantage, for example, that an even higher profile can be produced by hot forming and the quality of the coin is further improved.

In a further technically advantageous embodiment of the minting method, the relief, the coin blank or the plate is formed from gold, silver, copper, platinum, a non-ferrous metal or an alloy. This achieves the technical advantage, for example, that particularly suitable materials are used to produce the coin.

Exemplary embodiments of the invention are shown in the drawings and are described in more detail below, in which:

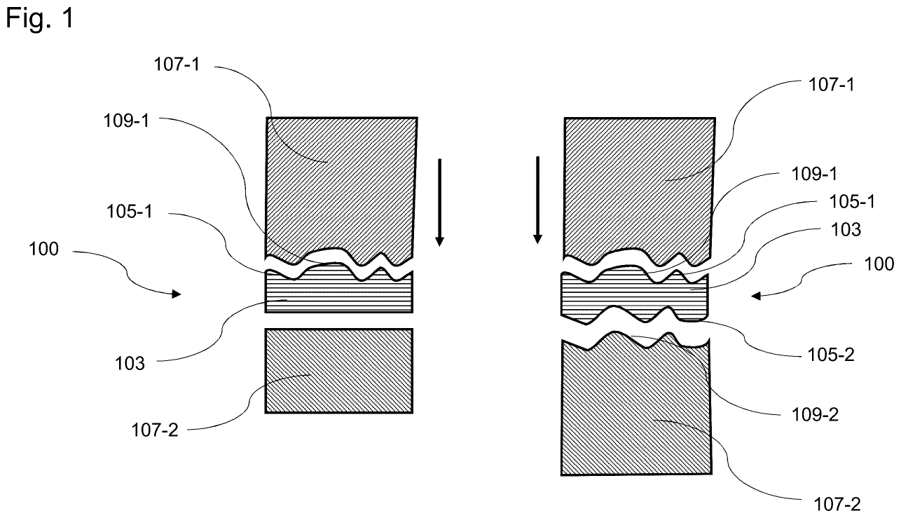

FIG. 1 shows a schematic view of a minting method;

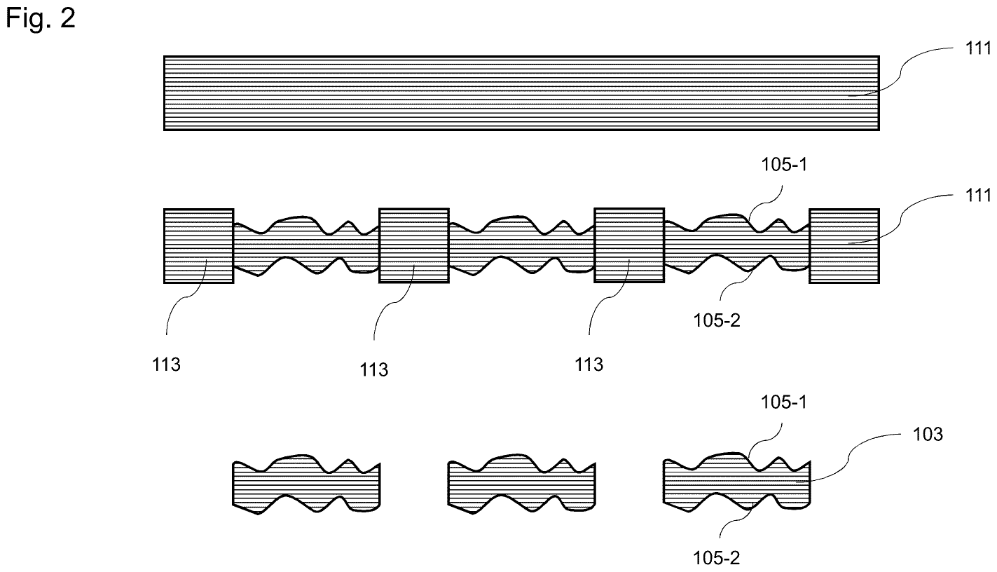

FIG. 2 shows a schematic view of a method for producing a coin blank with preformed relief;

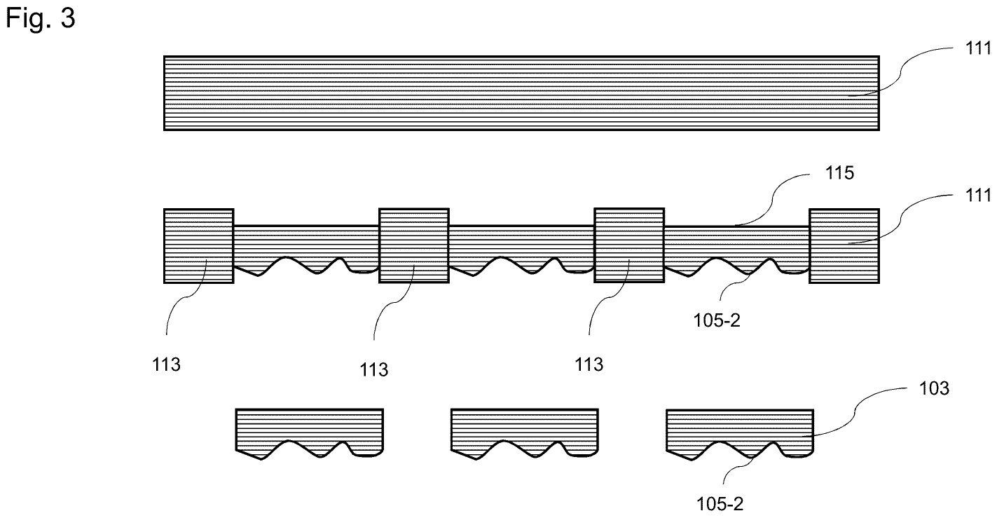

FIG. 3 shows a schematic view of a method for producing a coin blank by means of face-milling; and

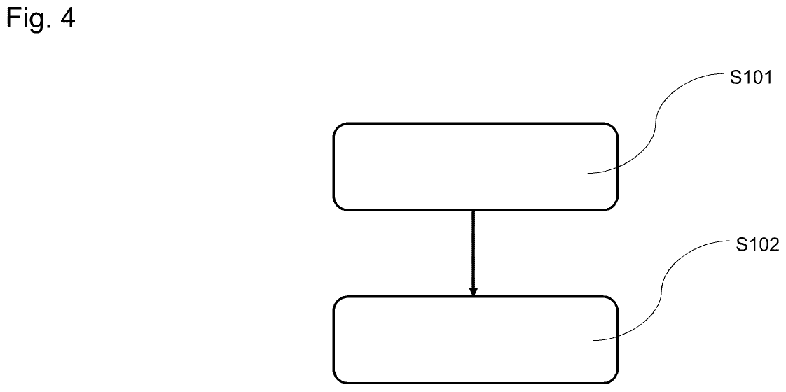

FIG. 4 shows a block diagram of a minting method for producing the coin.

FIG. 1 shows a schematic view of a minting method. First, a relief 105-1 and/or 105-2 is preformed on one or two sides of a coin blank 103. The relief 105-1 or 105-2 protrudes from the coin blank 103 in a raised manner. The relief 105-1 or 105-2 is the three-dimensional representation of a motif. The coin blank 103 is, for example, a round coin. The relief 105-1, 105-2 can, for example, be preformed in the desired three-dimensional shape by means of a machining process, such as a milling process.

The coin blank 103 with the relief is then subsequently minted by means of a minting method. For this purpose, the coin blank 103 with the preformed relief 105-1, 105-2 is located between the two coin dies 107-1 and 107-2. The preformed relief 105-1, 105-2 is subsequently minted by the coin dies 107-1 and 107-2 and the coin 100 is given its final shape. For this purpose, the coin dies 107-1 and 107-2 have a recess for further processing and shaping of the relief 105-1, 105-2.

FIG. 2 shows a schematic view of a method for producing a coin blank 103 with preformed relief 105-1 and/or 105-2. First, a plate 111 is used as a base for producing the coin blanks 103.

The plate 111 has a thickness of 3 mm, for example, and is formed from gold, silver, copper, platinum, a non-ferrous metal or an alloy. The plate 111 can be large enough for several coin blanks 103 to be produced from it. In this case, several reliefs 105-1 are milled side by side from the plate 111.

The three-dimensional reliefs 105-1 are preformed in the desired shape at several points in the plate 111, for example using a CNC process. The shape corresponds approximately to the shape of the relief 105-1 after the subsequent minting process. The reliefs 105-1 and 105-2 can be preformed on one or both sides of the plate 111. The three-dimensional coin blank 103 produced already represents the later model. The reliefs 105-1 arranged next to each other are spaced apart from each other in the plate 111.

Once the reliefs 105-1 and 105-2 have been preformed in the plate 111, the individual coin blanks 103 are cut out of the plate 111. This can be done by cutting out the intermediate areas 113 using a groove cutter. The coin blanks 103 are circular, for example, and have a diameter of 11 mm to 120 mm. The coin blanks 103 are then ready for the subsequent minting process.

FIG. 3 shows a schematic view of a method for producing the coin blank 103 by means of face-milling. The plate 111 is used as a base for producing the coin blanks 103. First, the plate 111 is face-milled on one or both sides so that the plate 111 has a uniform thickness, for example with a depth of approx. 0.1 mm. The face-milling is carried out continuously in a spiral pattern to prevent milling edges. The uniform thickness of the plate 111 can improve the quality of the minting.

In the face-milled plate 111, several reliefs 105-1 are then milled out of the plate 111 side by side. At the areas 115 of the plate 111 opposite the reliefs 105-2, the plate 111 is cut off. Here, the areas 115 opposite the reliefs 105-2 are removed evenly by means of a milling tool. This results in circular recesses with surfaces that correspond to the surfaces of the reliefs 105-2 on the opposite side.

Once the reliefs 105-2 have been preformed in the plate 111, the individual coin blanks 103 are cut out of the plate 111. This can be done by cutting out the intermediate areas 113 using a groove cutter. The coin blanks 103 are then circular, for example, and have a diameter of 11 mm to 120 mm.

FIG. 4 shows a block diagram of the minting method for producing the coin. The minting method comprises the step S101 of preforming the relief 105-1, 105-2 for the coin 100. The structure of the coin blank 103 can be adapted to produce a perfect minting (degree, shaping, shadow).

Subsequently, in step S102, the relief 105-1, 105-2 is subsequently minted with the coin die 107-1, 107-2. The minting method can be used to produce coins with particularly high and raised reliefs 105-1, 105-2. The height of the relief 105-1, 105-2 is, for example, 200% of the thickness of the coin blank 103.

The three-dimensional coin blank 103 is minted using the coin dies 107-1 and 107-2 in PP quality (PP-proof), for example. Reliefs of up to 200% per side with the highest level of detail and minting in proof quality are possible. The deformation can be 200% of the thickness of the coin blank 103 on one side or 200% on both sides.

The thickness of the coin blank 103 can be calculated using the formula:

$$X = Rg ⋆ 4 / ( Sg ⋆ π ⋆ D ⋆ D )$$

X is the thickness of the coin blank, Rg=the nominal weight of the coin blank, Sg the specific weight of the material and D the diameter of the coin die 107.

With a nominal weight of 31.1 g, a specific weight of 0.0105 g/mm³ and a diameter of 38.35 mm, the thickness X of the coin blank 103 is 2.565 mm. A relief of 200% therefore has a height of 5.13 mm in relation to the thickness of the coin blank 103. A relief of 400% has a height of 10.26 mm in relation to the thickness of the coin blank 103.

All the features explained and shown in connection with individual embodiments of the invention can be provided in different combinations in the subject matter according to the invention in order to simultaneously realize their advantageous effects.

All method steps can be implemented by devices that are suitable for executing the respective method step. All functions performed by the features of the subject matter can be a method step of a method.

The scope of protection of the present invention is given by the claims and is not limited by the features explained in the description or shown in the figures.

### REFERENCE LIST

100 Coin
103 Coin blank
105 Relief
107 Coin die
109 Side
111 Plate
113 Intermediate area
115 Area

1. A minting method for producing a coin (100), comprising the steps of:
preforming (S101) a relief (105-1, 105-2) for the coin (100); and
subsequently minting (S102) the relief (105-1, 105-2) with a coin die (107-1, 107-2).

2. The minting method according to claim 1, wherein the relief (105-1, 105-2) is preformed by means of a milling process.

3. The minting method according to claim 1, wherein a first relief (105-1) is preformed on one side (109-1) and a second relief (105-2) is preformed on an opposite side (109-2).

4. The minting method according to claim 1, wherein a first relief (105-1) is subsequently minted on one side (109-1) by a first coin die (107-1) and/or a second relief (105-2) is subsequently minted on an opposite side (109-2) by a second coin die (107-2).

5. The minting method according to claim 1, wherein the relief (105-1, 105-2) has a height of at least 200% of the thickness of the coin blank (103).

6. The minting method according to claim 1, wherein the relief (105-1, 105-2) is preformed in a plate (111).

7. The minting method according to claim 1, wherein the first side (109-1) and/or the second side (109-2) of the plate (111) is face-milled.

8. The minting method according to claim 6, wherein a coin blank (103) is cut out of the plate (111).

9. The minting method according to claim 1, wherein the preformed relief (105-1, 105-2) is heated before the subsequent minting.

10. The minting method according to claim 7, wherein the relief (105-1, 105-2), the coin blank (103) or the plate (111) is formed from gold, silver, copper, platinum, a non-ferrous metal or an alloy.
